(19) United States
(12) Patent Application Publication
(10) Pub. No.: US 2025/0247604 A1
(43) Pub. Date: Jul. 31, 2025

(54) IMAGE PICKUP APPARATUS, ACCESSORY APPARATUS, AND CONTROL METHOD THEREOF

(71) Applicant: CANON KABUSHIKI KAISHA, Tokyo (JP)

(72) Inventor: KEISUKE SAITO, Tokyo (JP)

(21) Appl. No.: 19/025,267

(22) Filed: Jan. 16, 2025

(30) Foreign Application Priority Data
Jan. 26, 2024 (JP) 2024-010210

(51) Int. Cl. H04N 23/62

(52) U.S. Cl. CPC H04N 23/62

(57) ABSTRACT

The image pickup apparatus to which a first accessory apparatus including a first operation ring having a rotational end is connectable. A controller allocates, in a case where the first accessory apparatus or a second accessory apparatus connected to the image pickup apparatus together with the first accessory apparatus includes a second operation ring having no rotational end, functions related to control of the first accessory apparatus or the image pickup apparatus to the first and second operation rings, and performs the control in accordance with operations of the first and second operation rings. The controller allocates a first function to the first operation ring, and in a case where the first function is included in functions allocatable to the second operation ring, allocates a second function to the second operation ring or restricts allocation of the first function to the second operation ring.

### BACKGROUND

### Technical Field

The present disclosure relates to an image pickup apparatus on which an accessory apparatus such as an interchangeable lens or an intermediate adapter is mounted.

### Description of Related Art

In some accessory apparatuses as described above, an operation ring is mounted as an operation member that can be rotationally operated by a user. Functions such as a manual focus function, a manual aperture function, and a manual shutter speed function are allocated to the operation ring.

There are two types of operation rings: a rotation-unlimited (endless) ring without rotational ends (operation ends) and a rotation-limited ring with rotational ends. The rotational position of the rotation-limited ring is associated with a set value in a function allocated to the rotation-limited ring. In this case, if the same function are allocated to both the rotation-limited ring and the endless ring, an operation of the endless ring causes a discrepancy between the rotational position of the rotation-limited ring and the set value.

Japanese Patent Laid-open No. 2009-222731 discloses an image pickup apparatus equipped with an operation member that is not used for aperture adjustment when an operation ring (rotation-limited ring) for a manual aperture function is provided on an interchangeable lens. Japanese Patent Laid-open No. 2021-184008 discloses an optical apparatus that enables resetting the correspondence between the rotational range of a rotation-limited ring for a manual focus function and a set value.

However, Japanese Patent Laid-open No. 2009-222731 and Japanese Patent Laid-open No. 2021-184008 do not consider a case where the rotation-limited ring and any other operation member such as an endless ring are each a general-purpose operation member to which a plurality of functions are allocatable.

### SUMMARY

One of the aspects of the present disclosure provides an image pickup apparatus capable of appropriately allocating functions to an endless ring and a rotation-limited ring.

An image pickup apparatus according to one aspect of the present disclosure is connectable to a first accessory apparatus including a first operation ring that has a rotational end. The image pickup apparatus includes a processor configured to, in a case where the first accessory apparatus or a second accessory apparatus connected to the image pickup apparatus together with the first accessory apparatus includes a second operation ring that has no rotational end, allocate functions related to control of the first accessory apparatus or the image pickup apparatus to the first and second operation rings, and configured to perform the control in accordance with operations of the first and second operation rings. The processor allocates a first function to the first operation ring, and, in a case where the first function is included in functions allocatable to the second operation ring, allocates a second function different from the first function to the second operation ring or restricts allocation of the first function to the second operation ring.

An image pickup apparatus according to another aspect of the present disclosure includes a processor configured to allocate functions to a first operation ring having a rotational end and a second operation ring having no rotational end, and configured to perform control in accordance with operations of the first and second operation rings in the functions allocated to the first and second operation rings. The processor allocates, to the first operation ring, the function different from that allocated to the second operation ring in a case where the functions allocatable to the first operation ring include at least part of the functions allocatable to the second operation ring.

An accessory apparatus according to further another aspect of the present disclosure is connectable to an image pickup apparatus. The accessory apparatus includes a first operation ring having a rotational end, a second operation ring having no rotational end, and a processor configured to transmit to the image pickup apparatus information enabling control in accordance with an operation of each of the first and second operation rings in a function allocated to each of the first and second operation rings.

Further features of various embodiments of the disclosure will become apparent from the following description of embodiments with reference to the attached drawings.

### BRIEF DESCRIPTION OF THE DRAWINGS

FIG. 1 is a block diagram illustrating the configuration of a camera system in Example 1.

FIG. 2 is a flowchart illustrating ring customization processing on a camera side in Example 1.

FIG. 3 is a flowchart illustrating ring customization processing on a lens side in Example 1.

FIG. 4 is a flowchart illustrating ring function allocation processing on the camera side in Example 1.

FIGS. 5A and 5B illustrate functions allocatable to operation rings in Example 1.

FIG. 6 illustrates combinations of initial functions of the operation rings in Example 1.

FIGS. 7A, 7B, and 7C illustrate an example of set values for a manual aperture function, their values, rotation-limited ring information, and rotation-limited ring position conversion data in Example 1.

FIG. 8 is a flowchart illustrating rotation-limited ring position data generation processing on the camera side in Example 1.

FIGS. 9A and 9B illustrate a function allocation example 1 in Example 1.

FIGS. 10A and 10B illustrate a function allocation example 2 in Example 1.

FIGS. 11A and 11B illustrate a function allocation example 3 in Example 1.

FIG. 12 illustrates the sequence of the ring customization processing in Example 1.

FIGS. 13A and 13B illustrate functions allocatable to the operation ring in Example 2.

FIG. 14 illustrates combinations of initial functions of the operation rings in Example 2.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Examples of the present disclosure will be described below with reference to the accompanying drawings.

### EXAMPLE 1

In Example 1, description will be made of a case where an accessory apparatus detachably connected to an image pickup apparatus is equipped with an operation ring having rotational ends (first operation ring; hereinafter referred to as a rotation-limited ring) and an operation ring having no rotational ends (second operation ring as a rotation-unlimited ring, hereinafter referred to as an endless ring). In the present example, mutually different functions are allocated to the a and the endless ring by a ring customization function of the image pickup apparatus.

### Configuration of Camera System

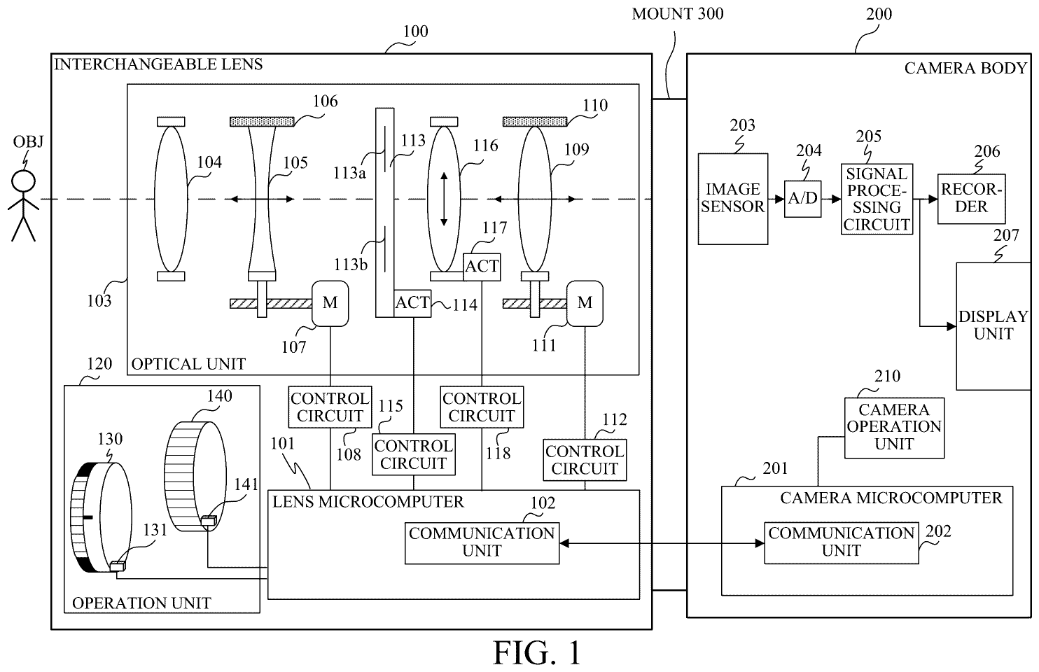

FIG. 1 illustrates the configuration of a lens interchangeable camera system constituted by a camera body 200 as the image pickup apparatus in Example 1 and an interchangeable lens 100 as the accessory apparatus. The interchangeable lens 100 is connected (mechanically mounted and electrically connected) to the camera body 200 through a mount 300 that is a connecting mechanism.

An intermediate adapter as at least one other accessory apparatus (second accessory apparatus) may be connected between the camera body 200 and the interchangeable lens (first accessory apparatus) 100. In this case, mutually different functions may be allocated to a rotation-limited ring and an endless ring provided on the intermediate adapter by the ring customization function.

In a case where one of a rotation-limited ring and an endless ring is provided on the interchangeable lens and the other is provided on the intermediate adapter, mutually different functions may be allocated to the rotation-limited ring and the endless ring by the ring customization function. The same applies in a case where the camera body 200, to which the interchangeable lens 100 including one of a rotation-limited ring and an endless ring is connected, is connected through a cable or wirelessly to another accessory apparatus including the other. The same also applies when one of a rotation-limited ring and an endless ring is provided on the interchangeable lens or the intermediate adapter and the other is provided on the camera body.

The interchangeable lens 100 and the camera body 200 can communicate through a non-illustrated communication terminal provided on the mount 300. The interchangeable lens 100 is supplied with power from the camera body 200 through a non-illustrated power source terminal provided on the mount 300.

The interchangeable lens 100 includes an optical unit 103. The optical unit 103 includes an image pickup optical system including, as optical elements disposed sequentially from an object OBJ side, a field lens 104, a zoom lens 105 that varies magnification, an aperture stop unit 113 that adjusts light quantity, an image stabilizing lens 116 that reduces (corrects) image blur, and a focus lens 109 that performs focus adjustment.

The zoom lens 105 and the focus lens 109 are held by lens holding frames 106 and 110, respectively. The lens holding frames 106 and 110 are guided movably by a non-illustrated guide shaft in an optical axis direction in which an optical axis (illustrated with a dashed line in the drawing) extends, and can be driven in the optical axis direction by actuators 107 and 111. The aperture stop unit 113 includes aperture blades 113a and 113b with changeable opening diameters, and the aperture blades 113a and 113b can be driven by an aperture stop actuator 114. The image stabilizing lens 116 can be driven in a direction orthogonal to the optical axis direction by an image stabilization actuator 117.

The interchangeable lens 100 includes an operation unit 120. The operation unit 120 includes a rotation-limited ring 130 and an endless ring 140.

The rotation-limited ring 130 is constituted by a ring member provided around an outer barrel of the interchangeable lens 100 and rotationally operable about the optical axis by a user, and its rotational operation is mechanically restricted at rotational ends that are the respective ends of a predetermined rotational range. A rotational position detection unit 131 detects the rotational position of the rotation-limited ring 130 and transfers position information indicating the detected rotational position to a lens microcomputer 101.

The endless ring 140 is constituted by a ring member provided around the outer barrel of the interchangeable lens 100 and rotationally operable about the optical axis by the user, and can be rotationally operated indefinitely (without restriction by rotational ends). A rotational position detection unit 141 detects the rotational position of the endless ring 140 and transfers position information indicating the detected rotational position to the lens microcomputer 101.

The lens microcomputer 101 is constituted by a computer including a CPU and the like, acquires the position information of the rotation-limited ring 130 from the rotational position detection unit 131, and acquires operation amount information indicating the operation amount (change amount of the rotational position) of the endless ring 140 based on the position information from the rotational position detection unit 141.

In the following description, the rotation-limited ring and the endless ring are collectively referred to as an operation ring. In addition, the position information of the rotation-limited ring and the operation amount information of the endless ring are collectively referred to as operation information (information in accordance with operations) of the operation ring.

In the present example, some (different from each other) of a plurality of functions can be selectively allocated to the operation ring (130 and 140). The plurality of functions include a manual focus function that moves the focus lens 109 in accordance with the operation information of the operation ring, and a manual aperture function that changes the opening diameter of the aperture stop unit 113 in accordance with the operation information. The functions also include a manual zoom function that moves the zoom lens 105 in accordance with the operation information, a manual ISO function that changes the ISO sensitivity of an image sensor 203 in accordance with the operation information, and a manual white balance (WB) function that changes white balance in accordance with the operation information. Set values of each function, for example, F-numbers of the manual aperture function are held in the camera body 200 or the interchangeable lens 100, and a set value is selected in accordance with the operation information.

The lens microcomputer 101 can communicate with a camera microcomputer 201 in the camera body 200 through a lens communication unit 102. The lens microcomputer 101 controls drive of the optical unit 103 and acquires its state through control circuits 108, 112, 115, and 118 based on commands and signals received from the camera microcomputer 201.

The interchangeable lens 100 may include a plurality of rotation-limited rings and a plurality of endless rings and may include a switch capable of switching enabling and disabling of operations of the rotation-limited ring 130.

One or a plurality of set values in, for example, a range in which the F-number can be set by the manual aperture function and a range in which the focal length can be set by the manual zoom function may be printed on the outer periphery of the rotation-limited ring 130. In addition, a display unit that displays the set value of a function allocated to the rotation-limited ring 130 may be provided on the interchangeable lens 100.

The camera body 200 includes the image sensor 203 such as a CCD sensor or a CMOS sensor, an A/D conversion circuit 204, a signal processing circuit 205, a recorder 206, the camera microcomputer 201, a display unit 207, and a camera operation unit 210.

The image sensor 203 photoelectrically converts an object image formed through the image pickup optical system in the interchangeable lens 100 and outputs an electric signal (analog signal). The A/D conversion circuit 204 converts the analog signal from the image sensor 203 into a digital signal. The signal processing circuit 205 generates an image signal by performing various kinds of image processing on the digital signal from the A/D conversion circuit 204. The signal processing circuit 205 also generates, from the image signal, focus information indicating the contrast state of the object image (focus state of the image pickup optical system) and luminance information indicating its exposure state. The signal processing circuit 205 outputs the image signal to the display unit 207, and the display unit 207 displays the image signal as a live view image used for checking the composition, the focus state, and the like.

The camera microcomputer 201 as a control means is a computer including a CPU and the like and controls the camera body 200 in accordance with an input from the camera operation unit 210 including an image pickup instruction switch, various setting switches, and the like. Through a camera communication unit 202, the camera microcomputer 201 transmits various kinds of commands and signals to the interchangeable lens 100 and receives lens data from the interchangeable lens 100. For example the camera microcomputer 201 transmits, to the interchangeable lens 100, an aperture control command including an aperture control amount in accordance with an input from the camera operation unit 210, thereby causing the lens microcomputer 101 to control the aperture stop unit 113. The camera microcomputer 201 also transmits a control timing signal periodically generated at the signal processing circuit 205 to the interchangeable lens 100.

### Function Allocation to Operation Ring

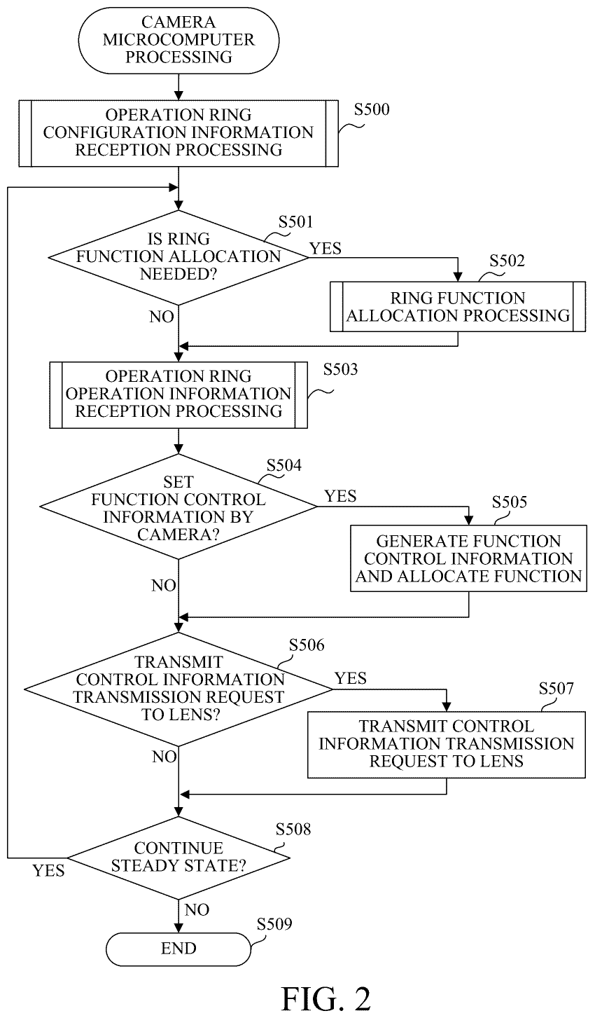

FIG. 2 is a flowchart illustrating ring customization processing that the camera microcomputer 201 as an allocation unit in the ring customization function of the camera body 200 executes in accordance with a computer program. The camera microcomputer 201 starts the present processing when the interchangeable lens 100 is mounted on the camera body 200 and the camera body 200 is powered on. Reference sign “S” means “step”.

At S500, the camera microcomputer 201 performs processing that receives (acquires) information (hereinafter referred to as operation ring configuration information) related to the operation ring configuration (existence of the rotation-limited ring and the endless ring) of the interchangeable lens 100 from the lens microcomputer 101 of the interchangeable lens 100 mounted on the camera body 200. The camera microcomputer 201 receives the operation ring configuration information from the lens microcomputer 101 by transmitting a transmission request command for the operation ring configuration information to the lens microcomputer 101. The operation ring configuration information is used in later processing.

Subsequently at S501, the camera microcomputer 201 determines whether functions need to be allocated to the operation ring indicated by the received operation ring configuration information, and performs processing at S502 in a case where the function allocation is needed. At initial execution of S501 after power on, the camera microcomputer 201 determines that the function allocation is needed. The camera microcomputer 201 also determines that the function allocation is needed in a case where the function allocation is selected or changed by the user through the camera operation unit 210. When having determined that the function allocation is not needed, the camera microcomputer 201 performs processing at S503.

At S502, the camera microcomputer 201 performs ring function allocation processing that specifies functions to be allocated to the operation ring. The processing will be described later in detail. As described above, mutually different functions are allocated to the rotation-limited ring and the endless ring in the present example. In this case, the functions may be functions for controlling mutually different control targets in the optical unit 103, or one of the functions may be a function that controls control targets and the other may be a disabling function not in charge of control of any control targets. Thereafter, the camera microcomputer 201 performs processing at S503.

At S503, the camera microcomputer 201 performs processing that receives (acquires) the operation information of the operation ring. Specifically, the operation information is received from the lens microcomputer 101 by transmitting a transmission request command for the operation information to the lens microcomputer 101. The operation information of the operation ring to which the disabling function is allocated is not received.

Subsequently at S504, the camera microcomputer 201 determines whether to set information (hereinafter referred to as function control information) indicating the set value of a function allocated to the operation ring. The function control information includes information of camera set values controlling the camera body 200 and information of lens set values for controlling the optical unit 103. The function control information may include information indicating whether to transmit the lens set values to the lens microcomputer 101 and information indicating timings of transmitting the lens set values to the lens microcomputer 101. When setting the function control information, the camera microcomputer 201 performs processing at S505. As for the specification of the function control information, only the function control information of a function allocated to the rotation-limited ring may be specified, or only the function control information of a function allocated to the endless ring may be specified. Moreover, whether to set the function control information may be determined for each function in advance or may be determined in processing at S502. For example, the function control information is not specified in a case where the disabling function is allocated to the operation ring. In a case where the function control information is not specified, the camera microcomputer 201 performs processing at S506.

Subsequently at S505, the camera microcomputer 201 generates, for a function for which it is determined to set the function control information at S504, the function control information based on the operation information of the operation ring acquired at S503. For example, in a case where the manual aperture function is allocated to the operation ring, a target F-number is generated as a lens set value. In the present example, the function control information is generated based on the operation information of the operation ring by using a ring-position-to-setting-value conversion table to be described later. Thereafter, the camera microcomputer 201 performs processing at S506.

At S506, the camera microcomputer 201 determines whether to transmit, to the lens microcomputer 101, a control information transmission command including the function control information generated for a function allocated to the operation ring, and proceeds to S507 in a case where the command is to be transmitted or S508 in a case where the command is not to be transmitted. For example, in a case where the function allocated to the operation ring is a function that controls the optical unit 103, it is determined to transmit the control information transmission command to the lens microcomputer 101. In a case where the operation information of the operation ring is not changed (the rotational position of the rotation-limited ring is not changed or the operation amount of the endless ring is zero), it is determined not to transmit the control information transmission command. In a case where the function allocated to the operation ring is not a function that controls the optical unit 103, as well, it is determined not to transmit the control information transmission command. Specifically, it is determined not to transmit the control information transmission command in a case where a function on the camera body side is allocated to the operation ring or in a case where a function that controls the optical unit 103 is allocated by the lens microcomputer 101 itself.

The timing and cycle of transmitting the control information transmission command may be adjusted based on a control timing signal periodically generated at the signal processing circuit 205 or may be only a timing right before start of still image pickup.

At S507, the camera microcomputer 201 transmits the control information transmission command to the lens microcomputer 101. The function control information included in the control information transmission command include a target F-number as a lens set value in a case where the manual aperture function is allocated to the operation ring. Thereafter, the camera microcomputer 201 performs processing at S508.

At S508, the camera microcomputer 201 determines whether to continue processing in the steady state of the camera body 200, and performs processing at S501 in a case where the processing is to be continued. Processing in the steady state is ended in a case where the camera body 200 is powered off, the interchangeable lens 100 is removed from the camera body 200, or the camera body 200 is not operated for a predetermined time by the user and the camera microcomputer 201 transitions to a sleep state. In this case, the present processing is ended at S509. In a case where the present processing is ended, the function allocated to the operation ring at S502 may be held in a nonvolatile memory mounted on the camera body 200.

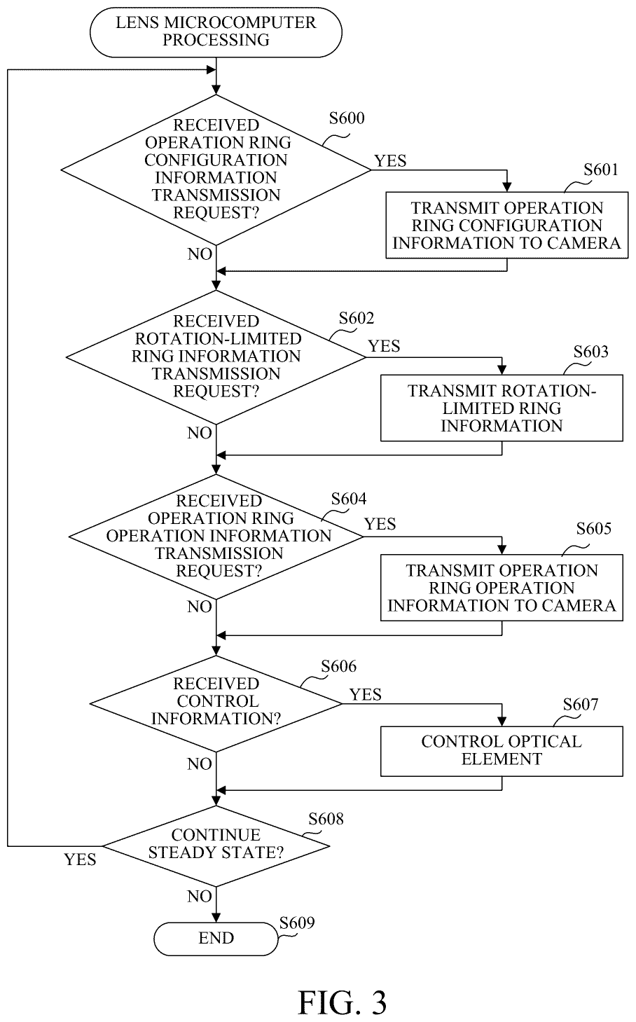

FIG. 3 is a flowchart illustrating processing that the lens microcomputer 101 executes in accordance with a computer program in the ring customization function.

At S600, the lens microcomputer 101 determines whether a transmission request command for the operation ring configuration information is received from the camera microcomputer 201, and performs processing at S601 in a case where the command is received or processing at S602 in a case where the command is not received.

At S601, the lens microcomputer 101 transmits the operation ring configuration information to the camera microcomputer 201. Then, the lens microcomputer 101 performs processing at S602.

At S602, the lens microcomputer 101 determines whether a transmission request command for information related to the rotation-limited ring (hereinafter referred to as rotation-limited ring information) is received from the camera microcomputer 201, and performs processing at S603 in a case where the command is received or processing at S604 in a case where the command is not received.

Unlike the operation information of the rotation-limited ring, the rotation-limited ring information is information indicating specifications of the rotation-limited ring. For example, the rotation-limited ring information is information indicating success or failure of function allocation to the rotation-limited ring, or information indicating a range in which the rotation-limited ring can be operated. The information indicating the operable range of the rotation-limited ring may be information of minimum and maximum values of the position information of the rotation-limited ring or may be a total number of values of the position information of the rotation-limited ring.

At S603, the lens microcomputer 101 transmits the rotation-limited ring information to the camera microcomputer 201. Then, the lens microcomputer 101 performs processing at S604.

At S604, the lens microcomputer 101 determines whether a transmission request command for the operation information of the operation ring is received from the camera microcomputer 201, and performs processing at S605 in a case where the command is received or processing at S606 in a case where the command is not received.

At S605, the lens microcomputer 101 transmits the operation information to the camera microcomputer 201. Then, the lens microcomputer 101 performs processing at S606.

At S606, the lens microcomputer 101 determines whether the control information transmission command including the function control information is received from the camera microcomputer 201, and performs processing at S607 in a case where the command is received or processing at S608 in a case where the command is not received.

At S607, the lens microcomputer 101 controls an optical element as a relevant control target in the optical unit 103 based on the function control information (lens set values) included in the received control information transmission command. Then, the lens microcomputer 101 performs processing at S608.

At S608, the lens microcomputer 101 determines whether to continue processing in the steady state of the interchangeable lens 100, and performs processing at S600 when continuing the processing. The processing in the steady state is ended in a case where a request command to end operation is received from the camera microcomputer 201 or in a case where the interchangeable lens 100 has not been operated for a predetermined time by the user and the lens microcomputer 101 has transitioned to a sleep state. In this case, the present processing is ended at S609.

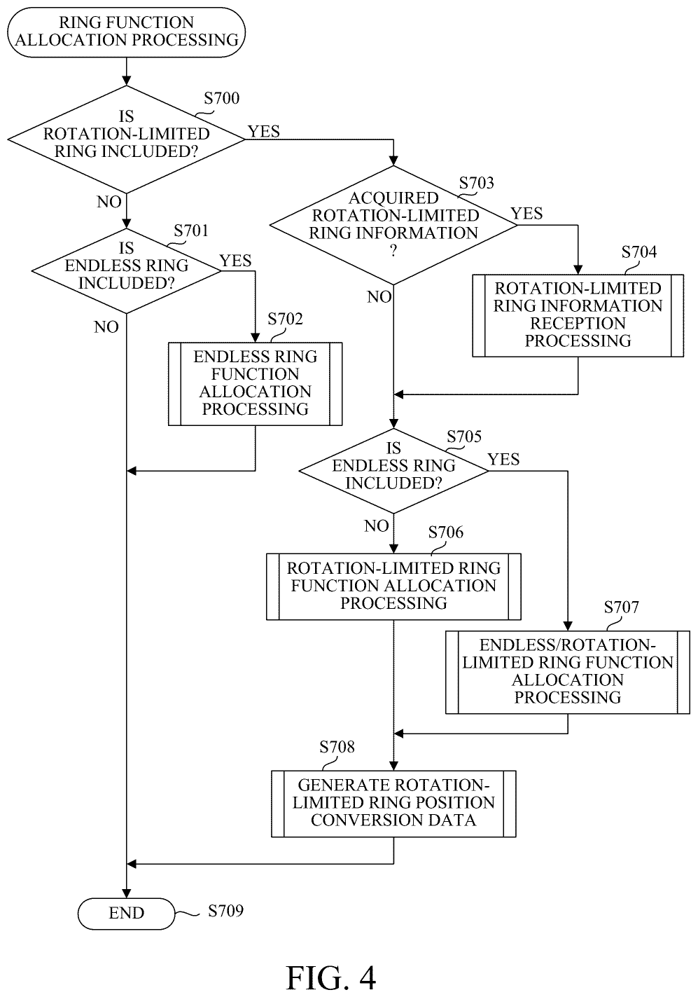

FIG. 4 is a flowchart illustrating processing that determines a function to be allocated to the operation ring, which is performed by the camera microcomputer 201 at S502 in FIG. 2.

At S700, the camera microcomputer 201 determines whether the interchangeable lens 100 includes the rotation-limited ring based on the operation ring configuration information acquired at S500 in FIG. 2. The camera microcomputer 201 performs processing at S703 in a case where the rotation-limited ring is included, or performs processing at S701 in a case where the rotation-limited ring is not included.

At S701, the camera microcomputer 201 determines whether the interchangeable lens 100 includes the endless ring based on the operation ring configuration information. The camera microcomputer 201 performs processing at S702 in a case where the endless ring is included, or ends the present processing at S709 in a case where the endless ring is not included.

At S702, the camera microcomputer 201 allocates, to the endless ring, one of a plurality of functions allocatable to the endless ring. This processing of function allocation to the endless ring differs between initial setting and change of an allocated function by a user operation, and each function allocation processing will be described later. When processing at S702 has ended, the camera microcomputer 201 ends the present processing at S709.

At S703, the camera microcomputer 201 determines whether to acquire the rotation-limited ring information, and performs processing at S704 in a case where the information is to be acquired or processing at S705 in a case where the information is not to be acquired. Whether to acquire the rotation-limited ring information may be determined only based on existence of the rotation-limited ring, and it may be determined to acquire the rotation-limited ring information in a case where the rotation-limited ring is included but the rotation-limited ring information is yet to be acquired. Alternatively, determination data for determining whether to acquire the rotation-limited ring information may be received from the interchangeable lens 100 and whether to acquire the rotation-limited ring information may be determined based on the data.

At S704, the camera microcomputer 201 transmits a rotation-limited ring information transmission request for acquiring the rotation-limited ring information to the lens microcomputer 101, and receives the rotation-limited ring information transmitted from the lens microcomputer 101. Then, the lens microcomputer 101 performs processing at S705.

At S705, similarly to S701, the camera microcomputer 201 determines whether the interchangeable lens 100 includes the endless ring, and performs processing at S707 in a case where the endless ring is included or processing at S706 in a case where the endless ring is not included.

At S706, the camera microcomputer 201 allocates one of a plurality of functions allocatable to the rotation-limited ring to the rotation-limited ring. Then, the lens microcomputer 101 performs processing at S708.

At S707, the camera microcomputer 201 allocates, to the rotation-limited ring, one of the plurality of functions allocatable to the rotation-limited ring and allocates, to the endless ring, one of the plurality of functions allocatable to the endless ring. In this case, mutually different functions are allocated to the rotation-limited ring and the endless ring. Then, the lens microcomputer 101 performs processing at S708.

The processing of function allocation to the rotation-limited ring at S706 and S707 differs between initial setting and change of an allocated function by a user operation, and each processing will be described later.

At S708, the camera microcomputer 201 generates, for the function allocated to the rotation-limited ring, rotation-limited ring position conversion data for generating the function control information based on the rotation-limited ring information. The rotation-limited ring position conversion data is data for converting the position information of the rotation-limited ring into a set value of the function (control), that is, information related to a set value in accordance with the rotational position of the rotation-limited ring, and corresponds to the above-described ring-position-to-setting-value conversion table. Generation of the rotation-limited ring position conversion data will be described later. The data related to a set value in accordance with the rotational position of the rotation-limited ring may be data indicating the set value itself for the rotational position of the rotation-limited ring or may be data of a value that can be converted into the set value.

### Functions Allocatable to Operation Ring

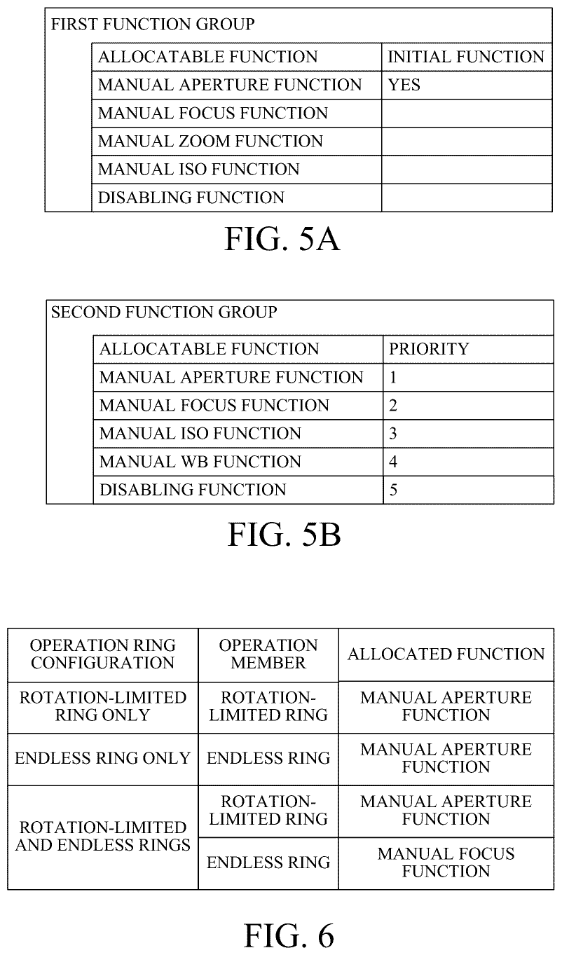

FIGS. 5A and 5B illustrate functions allocatable to the operation ring by the ring customization function in the present example. FIG. 5A illustrates a first function group that is a plurality of functions allocatable to the rotation-limited ring, and FIG. 5B illustrates a second function group that is a plurality of functions allocatable to the endless ring. The first and second function groups are held as function group data in the camera body 200 and do not vary depending on the operation ring configuration of the interchangeable lens 100.

At S706 and S707 in FIG. 4, the camera microcomputer 201 selects one function in the first function group in accordance with change of the operation ring configuration, change of the image pickup mode of the camera body 200, and change of an allocated function by a user operation to be described later, and allocates the function to the rotation-limited ring. The first function group includes the manual aperture function, the manual focus function, the manual zoom function, the manual ISO function, and the disabling function described above.

The following first describes ring function allocation processing in a case where the camera microcomputer 201 allocates the manual focus function to the operation ring at S502 in FIG. 2. Allocation of the manual focus function is performed when the user selects the manual focus function on a ring function allocation setting screen displayed on the display unit (function selection unit) 207 of the camera body 200 as described later. This is the same for the other functions. The manual focus function may be allocated when the user operates a non-illustrated physical switch for selecting the manual focus function, which is provided on the interchangeable lens 100. Information of the physical switch may be included in the rotation-limited ring information.

The manual focus function is a function that controls drive of the focus lens 109 in accordance with a user operation of the operation ring of the interchangeable lens 100, and the camera microcomputer 201 does not perform autofocus (AF) control of the focus lens 109. Thus, the camera microcomputer 201 does not receive the operation information of the operation ring to which the manual focus function is allocated at S503 in FIG. 2. The camera microcomputer 201 generates the function control information including information indicating a manual focus mode at S505, and transmits the function control information to the lens microcomputer 101 at S507. Having received the information indicating the manual focus mode at S606 in FIG. 3, the lens microcomputer 101 controls the focus lens 109 based on the operation information of the operation ring to which the manual focus function is allocated at S607.

The following describes ring function allocation processing in a case where the camera microcomputer 201 allocates the manual aperture function to the operation ring at S502. The manual aperture function is a function that controls drive of the aperture stop unit 113 in accordance with a user operation of the operation ring. When the manual aperture function is allocated to the operation ring, the camera microcomputer 201 receives the operation information of the operation ring to which the manual aperture function is allocated at S503. Then, the camera microcomputer 201 determines to set the function control information of the manual aperture function at S504 and generates a target F-number as a lens set value based on the operation information of the operation ring to which the manual aperture function is allocated at S505. Then at S506, the camera microcomputer 201 determines to transmit the lens set value to the lens microcomputer 101 at S507 right before start of exposure for still image pickup in a still image pickup mode or at timings in a predetermined cycle in a motion image pickup mode. In a case where the target F-number to be transmitted is the same as the previous target F-number, it may be determined not to transmit the lens set value to the lens microcomputer 101. In the still image pickup mode, the F-number may be set as bright as possible in a state in which a live view image is displayed from the perspective of autofocus (AF) accuracy. Thus, another target F-number different from the target F-number generated based on the operation information of the operation ring may be transmitted to the lens microcomputer 101. Having received the target F-number from the camera microcomputer 201 at S606, the lens microcomputer 101 controls the aperture stop unit 113 based on the received target F-number at S607.

The following describes ring function allocation processing in a case where the camera microcomputer 201 allocates the manual ISO function to the operation ring at S502. The manual ISO function is a function that controls the ISO sensitivity of the image sensor 203 included in the camera body 200 in accordance with a user operation of the operation ring. In a case where the manual ISO function is allocated to the operation ring, the camera microcomputer 201 receives the operation information of the operation ring to which the manual ISO function is allocated at S503. Then, the camera microcomputer 201 determines to set the function control information of the manual ISO function at S504 and specifies an ISO value as a camera set value at S505. Since the manual ISO function is a function that does not control the optical unit 103 of the interchangeable lens 100, the camera microcomputer 201 does not transmit the lens set value to the lens microcomputer 101 at S506.

The following describes ring function allocation processing when the camera microcomputer 201 allocates the disabling function to the operation ring at S502. In a case where the disabling function is allocated to the operation ring, the camera microcomputer 201 does not receive the operation information of the operation ring at S503 and determines not to set the function control information at S504. Since the disabling function is a function that controls nothing, the camera microcomputer 201 transmits no lens set value to the lens microcomputer 101 at S506.

The first function group is not limited to the functions illustrated in FIG. 5A but may include another function such as the manual WB function. The camera microcomputer 201 sets the manual aperture function in the first function group as the initial function. However, the initial function may be changed depending on the image pickup mode or may be set by the user in advance. Initial setting that sets the initial function will be described later.

At S702 and S707 in FIG. 4, the camera microcomputer 201 selects one function in the second function group in accordance with change of the operation ring configuration, change of the image pickup mode of the camera body 200, and change of an allocated function by a user operation to be described later, and allocates the function to the endless ring. The second function group includes the manual aperture function, the manual focus function, the manual ISO function, the manual WB function, and the disabling function described above. The second function group may include another function such as a manual shutter speed function.

The camera microcomputer 201 sets priorities to the plurality of functions included in the second function group. In FIG. 5B, the priority level is lower as the numerical value of the priority is larger, and the priority level decreases in the order of the manual aperture function, the manual focus function, the manual ISO function, the manual WB function, and the disabling function. However, these priorities are merely exemplary and other priorities may be set. The camera microcomputer 201 sets an initial setting function based on the priority.

### Initial Setting of Allocation Function

FIG. 6 illustrates the initial function allocated to the operation ring in the initial setting for each operation ring configuration. In a case where the interchangeable lens 100 includes only the rotation-limited ring, the camera microcomputer 201 allocates the manual aperture function, which is an initial setting function in the first function group, to the rotation-limited ring at S706 in FIG. 4.

In a case where the interchangeable lens 100 includes only the endless ring, the camera microcomputer 201 allocates the manual aperture function, which is a function with the highest priority in the second function group, to the endless ring at S702 in FIG. 4.

In a case where the interchangeable lens 100 includes both the rotation-limited ring and the endless ring, the camera microcomputer 201 first allocates the manual aperture function, which is the initial function in the first function group, to the rotation-limited ring at S707 in FIG. 4. Subsequently, the camera microcomputer 201 allocates the manual focus function with the highest priority except for the manual aperture function in the second function group to the endless ring.

A non-illustrated physical switch (function selection unit) for selecting a function may be provided on the interchangeable lens 100. In this case, initial setting functions to be allocated to the rotation-limited ring and the endless ring may be set in accordance with a user operation of the physical switch. In a case where information of an initial setting function is held in the nonvolatile memory, the initial setting function may be set based on the information.

### Generation of Rotation-Limited Ring Position Conversion Data

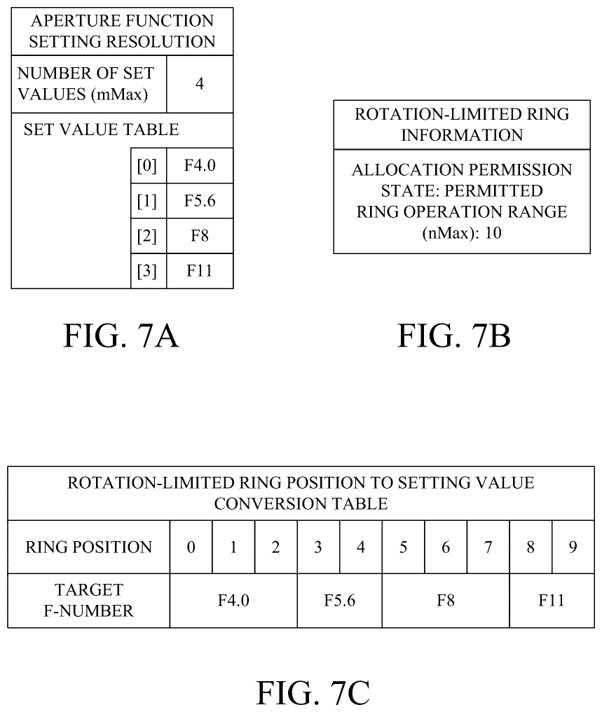

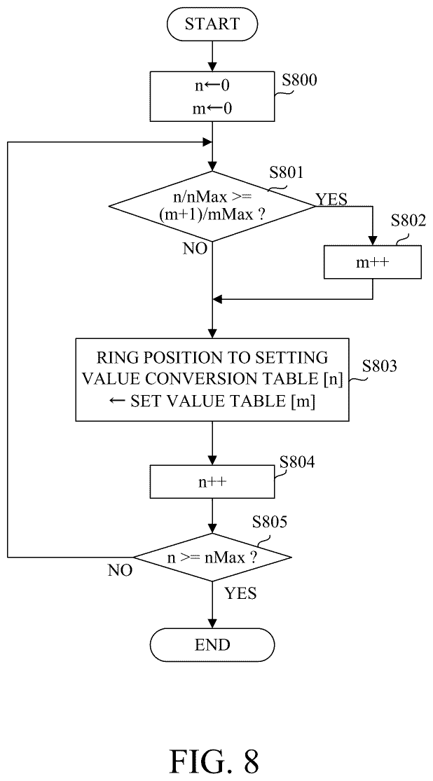

Generation of the rotation-limited ring position conversion data (ring-position-to-setting-value conversion table) will be described below with reference to FIGS. 7A, 7B, 7C, and 8.

FIG. 7A illustrates the number of set values of the F-number and its set value table in the rotation-limited ring position conversion data in the manual aperture function. In the present example, four (mMax) F-numbers of 0 to 3 (F4.0, F5.6, F8,and F11) can be set in the operable range of the rotation-limited ring, which is obtained from the rotation-limited ring information.

FIG. 7B illustrates the rotation-limited ring information acquirable from the interchangeable lens 100. The rotation-limited ring information indicates success or failure of function allocation to the rotation-limited ring as described above, and the operable range of the rotation-limited ring. The operable range of the rotation-limited ring in the present example consists of 10 levels (nMax) that the position of the rotation-limited ring can take.

FIG. 7C illustrates the ring-position-to-setting-value conversion table in the manual aperture function, which is generated in rotation-limited ring position conversion data generation processing illustrated in FIG. 8. In the table, the F-number at four levels is associated with the position of the rotation-limited ring at 10 levels of “0” to “9”. Specifically, F4.0 is associated with the position of the rotation-limited ring at “0” to “2”, F5.6 is associated with the position at “3” and “4”, F8 is associated with the position at “5” to “7”, and F11 is associated with the position at “8” and “9”. From the table, a target F-number in accordance with the position of the rotation-limited ring is read and a lens set value in the manual aperture function is generated.

FIG. 8 is a flowchart illustrating the rotation-limited ring position conversion data generation processing. First at S800, the camera microcomputer 201 initializes counter variables m and n to zero.

Subsequently at S801, the camera microcomputer 201 compares n/nMax and (m+1)/mMax. The value nMax is the operable range (10 levels) of the rotation-limited ring, included in the rotation-limited ring information, and the value mMax is the number (four) of F-numbers that can be set in the operable range of the rotation-limited ring. Processing at S802 is performed in a case where n/nMax is equal to or larger than (m+1)/mMax, or processing at S803 is performed otherwise.

At S802, the camera microcomputer 201 increments the counter variable m by one. Then, the lens microcomputer 101 performs processing at S803.

At S803, the camera microcomputer 201 substitutes an F-number designated by the counter variable m in a set value table including the four F-numbers into a target F-number designated by the counter variable n in the ring-position-to-setting-value conversion table.

Subsequently at S804, the camera microcomputer 201 increments the counter variable n by one.

Subsequently at S805, the camera microcomputer 201 compares the counter variable n with nMax, and continues the present processing at S801 in a case where n is smaller than nMax. The camera microcomputer 201 ends the present processing in a case where n is equal to or larger than nMax. Accordingly, production of the ring-position-to-setting-value conversion table is completed.

The ring-position-to-setting-value conversion table produced in this manner, which is illustrated in FIG. 7C, can be used to set a target F-number as the function control information (lens set value) based on the position information of the rotation-limited ring at S505 in FIG. 2.

The calculation method of rotation-limited ring-position-to-setting-value conversion data is not limited to that described above with reference to FIGS. 7A, 7B, 7C, and 8. For example, the camera microcomputer 201 may acquire, as the rotation-limited ring information, an F-number at the current position (actual position) of the rotation-limited ring and maximum and minimum F-numbers as maximum and minimum set values that the aperture stop unit 113 can take in the operable range of the rotation-limited ring. Then, an F-number may be associated with each position of the rotation-limited ring in accordance with the relation between the current F-number and the maximum and minimum F-numbers.

### Function Allocation Example 1

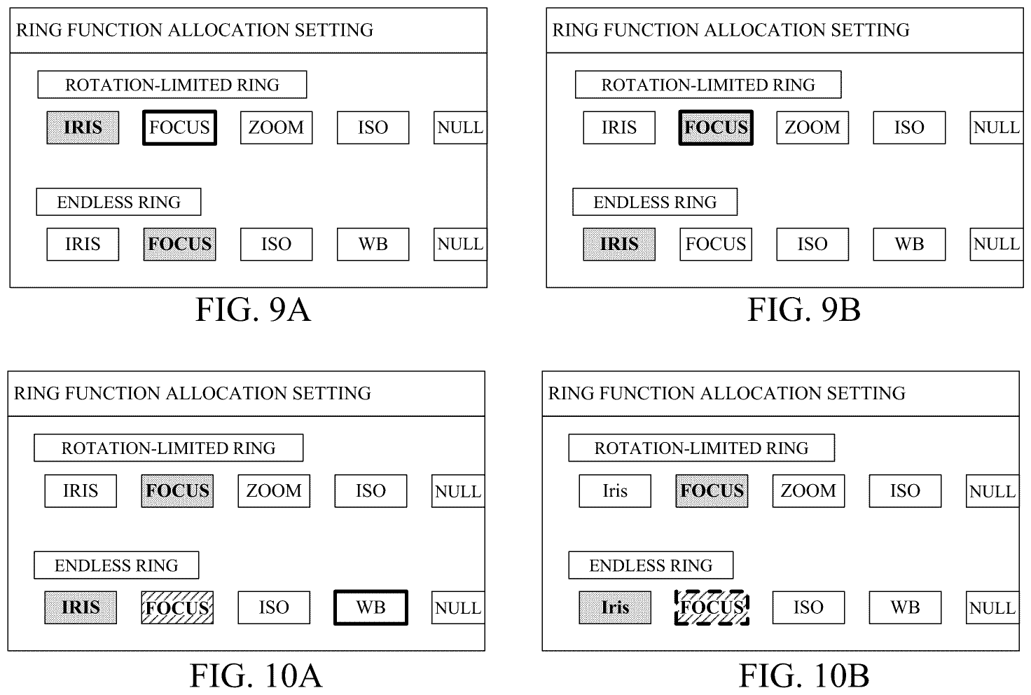

FIGS. 9A and 9B illustrates an example of the ring function allocation setting screen displayed on the display unit 207. The ring function allocation setting screen displays Iris (the manual aperture function), Focus (the manual focus function), Zoom (the manual zoom function), ISO (the manual ISO function), and NULL (the disabling function) in the first function group allocatable to the rotation-limited ring. In addition, Iris, Focus, ISO, WB (the manual WB function), and NULL in the second function group allocatable to the endless ring are displayed. The camera microcomputer 201 allocates functions to the rotation-limited ring and the endless ring when the user performs operations for selecting functions to be allocated to the rotation-limited ring and the endless ring while viewing the ring function allocation setting screen for the rings, including the disabling function.

FIGS. 9A and 9B illustrate an example in which when a function allocated to the rotation-limited ring is changed, a function other than the function allocated to the rotation-limited ring is automatically allocated to the endless ring. Specifically, FIG. 9A illustrates a state in which Iris is allocated to the rotation-limited ring and Focus is allocated to the endless ring (displayed in gray). The black solid frame is a selection frame that is moved by a user operation, and the selection frame in the diagram is positioned on Focus, which is allocatable to the rotation-limited ring.

FIG. 9B illustrates a state after the user selects Focus as a function to be allocated to the rotation-limited ring (in other words, changes Iris to Focus). Upon the selection of Focus for the rotation-limited ring, Iris with the highest priority except for Focus in the second function group allocatable to the endless ring is automatically allocated. In this case, a target F-number may be set to be an F-number in accordance with the setting and state of the camera body 200, or an F-number that is set by the previous operation of the endless ring may be held and set as the target F-number. Alternatively, an F-number as an initial value that is set in advance may be set as the target F-number.

When Iris is switched from a function of the endless ring to a function of the rotation-limited ring, the target F-number as a lens set value is changed to a target F-number corresponding to the position information of the rotation-limited ring. For example, when Iris is switched to a function of the rotation-limited ring while the target F-number is set to F8.0 by the endless ring and the ring position of the rotation-limited ring is “1”, the target F-number is changed to F4.0, which corresponds to the ring position “1” of the rotation-limited ring.

Function Allocation Example 2

FIGS. 10A and 10B illustrate an example of the ring function allocation setting screen displayed on the display unit 207, which is different from that in FIGS. 9A and 9B. As in FIGS. 9A and 9B, the ring function allocation setting screen displays Iris, Focus, Zoom, ISO, and NULL in the first function group allocatable to the rotation-limited ring. In addition, Iris, Focus, ISO, WB, and NULL in the second function group allocatable to the endless ring are displayed.

FIGS. 10A and 10B illustrates an example in which when a function to be allocated to the rotation-limited ring is selected, functions allocatable to the endless ring are restricted to those other than the function allocated to the rotation-limited ring. Specifically, FIG. 10A illustrates a state in which Focus is allocated to the rotation-limited ring and Iris is allocated to the endless ring. In this state, Focus, which is allocated to the rotation-limited ring, cannot be selected for the endless ring (hatched). The selection frame illustrated with the black solid frame is positioned on WB, which is allocatable to the endless ring.

FIG. 10B illustrates a state in which the selection frame for the endless ring is moved onto Focus by the user. In this case, the selection frame changes from the black solid frame to the black dashed frame to display that Focus cannot be allocated to the endless ring. In other words, functions allocatable to the endless ring are restricted to those other than Focus, which is allocated to the rotation-limited ring. Instead of changing the selection frame, the user may be prevented from moving the selection frame for the endless ring onto the function allocated to the rotation-limited ring.

### Function Allocation Example 3

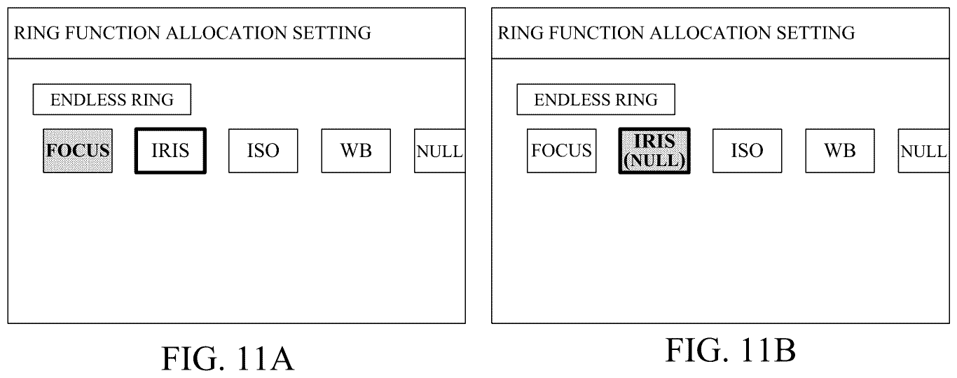

FIGS. 11A and 11B illustrate an example of the ring function allocation setting screen displayed on the display unit 207, which is different from FIGS. 9A and 9B and FIGS. 10A and 10B. The ring function allocation setting screen displays Focus, Iris, ISO, WB, and NULL in the second function group allocatable to the endless ring. In this example, Iris is already allocated to the rotation-limited ring by a user operation of the above-described physical switch, and the first function group for the rotation-limited ring is not displayed on the ring function allocation setting screen.

FIGS. 11A and 11B illustrate an example in which the disabling function is automatically set to the endless ring when Iris, which is the same function as that allocated to the rotation-limited ring, is selected for the endless ring. Specifically, when Iris is selected as a function to be allocated to the endless ring by the user as illustrated in FIG. 11A, the disabling function instead of Iris is automatically allocated to the endless ring as illustrated in FIG. 11B. In this case, “(NULL)” is displayed in the frame of Iris on the ring function allocation setting screen.

The above-described function allocation examples 1 to 3 are merely exemplary, and any other function allocation may be performed. For example, an operation unit capable of collectively allocating functions of the rotation-limited ring and the endless ring in accordance with a user operation may be provided on the camera body 200.

The above description is made of a case where the same function for controlling the same control target is not allocated to the rotation-limited ring and the endless ring. However, functions for controlling the same control target may be allocated to the rotation-limited ring and the endless ring, and a set value that can be set by one of the rings and a set value that can be set by the other ring (or ranges of set values) may be differentiated from each other. In this case, functions for controlling the same control target are mutually different functions because set values that can be set with the functions are different from each other. For example, in a case where the manual aperture function is allocated to the rotation-limited ring and the endless ring, a target F-number that can be set by the rotation-limited ring may be offset from a target F-number that can be set by the endless ring. In this case, a rough adjustment function and a fine adjustment function in the manual aperture function are allocated as separate functions to the endless ring and the rotation-limited ring, respectively. However, the rough adjustment function and the fine adjustment function in the manual aperture function may be allocated as separate functions to the rotation-limited ring and the endless ring, respectively.

### Sequence of Ring Customization Processing

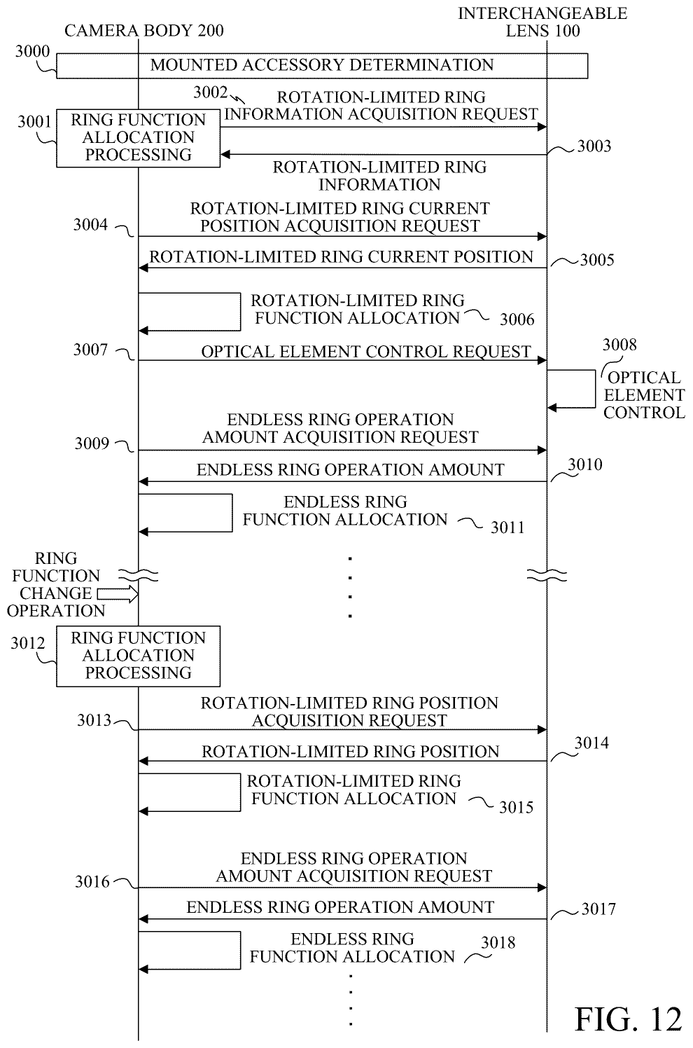

FIG. 12 illustrates the flow of processing in the camera body 200 (the camera microcomputer 201) and the interchangeable lens 100 (the lens microcomputer 101) in the ring customization processing. In the following, detailed description of processing already described with reference to FIGS. 2 to 4 will be omitted.

In processing 3000, the camera microcomputer 201 performs accessory determination processing that determines the kind of an accessory apparatus mounted on the camera body 200 and the operation ring configuration of the accessory apparatus.

In processing 3001, the camera microcomputer 201 performs the processing described with reference to S502 in FIG. 2 and FIG. 4 as initial setting of the initial function to the operation ring.

In processing 3002, the camera microcomputer 201 transmits a transmission request command for the rotation-limited ring information to the lens microcomputer 101 as described above at S704 in FIG. 4. Having received the transmission request command for the rotation-limited ring information at S602 in FIG. 3, the lens microcomputer 101 transmits the rotation-limited ring information to the camera microcomputer 201 in processing 3003 (S603).

In processing 3004, the camera microcomputer 201 transmits a transmission request command for the operation information (current position information) of the rotation-limited ring to the lens microcomputer 101 as described above at S503. Having received the transmission request command for the operation information at S604, the lens microcomputer 101 transmits the current position information of the rotation-limited ring to the camera microcomputer 201 in processing 3005 (S605).

In processing 3006, the camera microcomputer 201 generates the function control information based on the position information of the rotation-limited ring as described above at S505 to S507 and allocates, to the rotation-limited ring, a function that controls an optical member corresponding to the function control information.

In processing 3007, the camera microcomputer 201 transmits the control information transmission command (function control information) to the lens microcomputer 101 as described above at S507. Having received the function control information, the lens microcomputer 101 controls an optical element corresponding to a relevant function in processing 3008 (S606) based on a lens set value included in the received function control information.

In processing 3009, the camera microcomputer 201 transmits a transmission request command for the operation information (operation amount information) of the endless ring to the lens microcomputer 101 as described above at S503. Having received the transmission request command for the operation information of the endless ring at S604, the lens microcomputer 101 transmits the operation amount information of the endless ring to the camera microcomputer 201 in processing 3010 (S605).

In processing 3011, the camera microcomputer 201 generates the function control information based on the operation amount information of the endless ring as described above at S505 to S507 and allocates, to the endless ring, a function that controls an optical member corresponding to the function control information.

In processing 3012, in a case where a function allocated to the operation ring is changed, the camera microcomputer 201 determines that function allocation to the operation ring is needed at S501, and performs the ring function allocation processing that determines a function to be allocated to the operation ring as described above with reference to S502 and FIG. 4.

In processing 3013, the camera microcomputer 201 performs the same processing as processing 3004. In processing 3014, the lens microcomputer 101 performs the same processing as processing 3005.

In processing 3015, as in processing 3006, the camera microcomputer 201 generates the function control information based on the position information of the rotation-limited ring and allocates, to the rotation-limited ring, a function that controls an optical member corresponding to the function control information.

In processing 3016 the camera microcomputer 201 performs the same processing as processing 3009. In processing 3017, the lens microcomputer 101 performs the same processing as processing 3010.

In processing 3018, the camera microcomputer 201 generates, for the endless ring, the function control information of a function different from that allocated in processing 3011 and allocates, to the endless ring, a function that controls an optical member corresponding to the function control information.

In Example 1 described above, in a case where the interchangeable lens includes the rotation-limited ring to which a plurality of functions can be selectively allocated, a function different from a function allocated to the rotation-limited ring is allocated to the endless ring provided on the interchangeable lens or another accessory apparatus. Accordingly, discrepancy between the rotational position of the rotation-limited ring and a set value due to allocation of the same function to the rotation-limited ring and the endless ring can be avoided to achieve excellent operability of the interchangeable lens.

The above description in Example 1 is made of a function allocation example in which allocation to the rotation-limited ring is specified with priority over allocation to the endless ring, but allocation to the endless ring may be specified with priority over allocation to the rotation-limited ring. In this case, it is sufficient to interchange, between the rotation-limited ring and the endless ring, targets of each processing related to function allocation described above in Example 1.

### EXAMPLE 2

Example 2 will be described below. In Example 2 as well, in a case where the interchangeable lens includes the rotation-limited ring and the endless ring, functions that control the same control target are not allocated to the rotation-limited ring and the endless ring, and a function different from that to the rotation-limited ring is allocated to the endless ring. The configuration of a camera system in the present example is the same as that in Example 1, but the first function group allocatable to the rotation-limited ring and the second function group allocatable to the endless ring in the present example are different from those in Example 1.

Functions Allocatable to Operation Ring

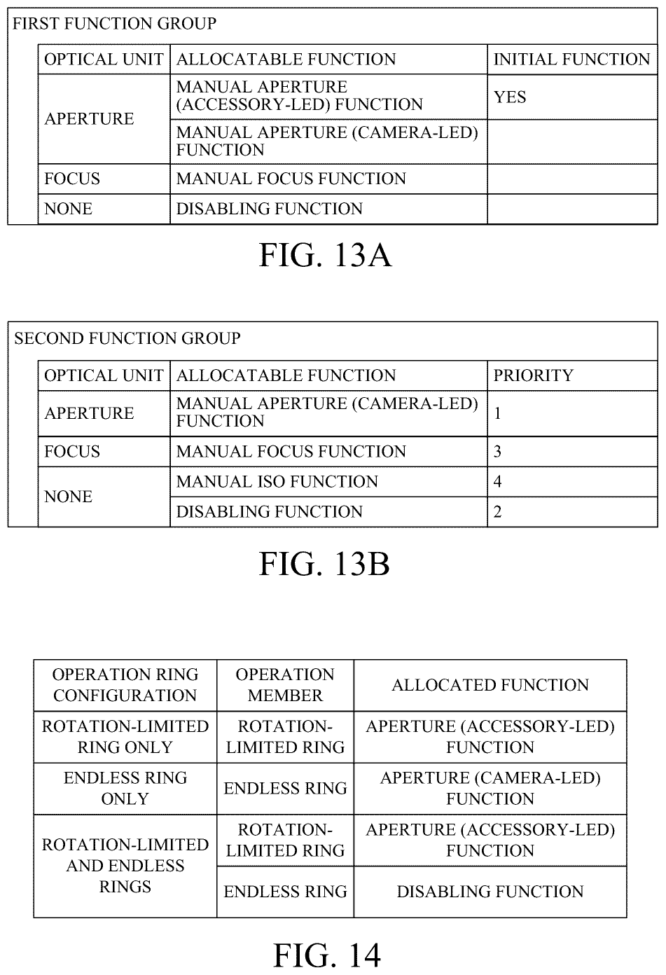

FIGS. 13A and 13B illustrate functions allocatable to the operation ring by the ring customization function in the present example. FIG. 13A illustrates the first function group that is a plurality of functions allocatable to the rotation-limited ring, and FIG. 13B illustrates the second function group that is a plurality of functions allocatable to the endless ring.

The first function group includes a manual aperture (accessory-led) function as an accessory-led control function that is a second control function, a manual aperture (camera-led) function as a camera-led control function that is a first control function, the manual focus function, and the disabling function. In the present example, the manual aperture (accessory-led) function is set as the initial function of the rotation-limited ring.

The manual aperture (accessory-led) function is a function with which the lens microcomputer 101 controls the aperture stop unit 113 as a first control target not through the camera microcomputer 201 based on the operation information of the operation ring. In a case where the manual aperture (accessory-led) function is allocated to the operation ring, the camera microcomputer 201 does not receive the operation information of the operation ring to which the manual aperture (accessory-led) function is allocated at S503 in FIG. 2. Then, the camera microcomputer 201 generates the function control information indicating that the manual aperture (accessory-led) function is allocated to the rotation-limited ring at S505, and transmits the function control information to the lens microcomputer 101 at S507.

Having received the function control information indicating that the manual aperture (accessory-led) function is allocated to the rotation-limited ring at S606 in FIG. 3, the lens microcomputer 101 controls the aperture stop unit 113 directly (not through the camera microcomputer 201) based on the operation information of the rotation-limited ring at S607. The manual aperture (accessory-led) function, which is a function that controls the aperture stop unit 113 not through the camera microcomputer 201, has better responsiveness than the manual aperture (camera-led) function to be described next.

The manual aperture (camera-led) function is a function with which the camera microcomputer 201 generates the function control information for the aperture stop unit 113 at S505 based on the operation information of the operation ring, which is acquired at S503, and transmits the function control information to the lens microcomputer 101 at S507. The manual aperture (camera-led) function is a function with which the camera microcomputer can control the aperture stop unit 113 at an optional timing at S506. The manual aperture (camera-led) function is allocated, for example, in a case where a bright F-number is set while a live view image is displayed from the perspective of AF accuracy in the still image pickup mode and control to stop down to a set F-number is performed at still image pickup.

The manual aperture (accessory-led) function and the manual aperture (camera-led) function have the same control target (aperture stop unit 113) but are separate functions.

The second function group includes the manual aperture (camera-led) function, the manual focus function, the manual ISO function, and the disabling function. Priorities are set to the plurality of functions included in the second function group as illustrated in FIG. 13B.

The disabling function, which disconnects the operation ring from control of any control target, may be allocated to the operation ring based on the operation state of a physical switch capable of switching enabling and disabling of operations of the operation ring.

### Initial Setting of Allocation Function

FIG. 14 illustrates the initial function allocated to the operation ring in the initial setting for each operation ring configuration. In a case where the interchangeable lens 100 includes only the rotation-limited ring, the camera microcomputer 201 allocates the manual aperture (accessory-led) function, which is the initial function in the first function group, to the rotation-limited ring at S706 in FIG. 4.

In a case where the interchangeable lens 100 includes only the endless ring, the camera microcomputer 201 allocates the manual aperture (camera-led) function, which is a function with the highest priority in the second function group, to the endless ring at S702 in FIG. 4.

In a case where the interchangeable lens 100 includes both the rotation-limited ring and the endless ring, the camera microcomputer 201 first allocates the manual aperture (accessory-led) function, which is the initial function in the first function group, to the rotation-limited ring at S707 in FIG. 4. Subsequently, the camera microcomputer 201 allocates, to the endless ring, the disabling function with the highest priority except for the manual aperture (camera-led) function related to control of the aperture stop unit 113 as the same first control target (optical element) as that of the manual aperture (accessory-led) function in the second function group. In this case, a function (for example, the manual focus function) other than the manual aperture (camera-led) function, the manual aperture (accessory-led) function, and the disabling function may be allocated to the endless ring.

In Example 2 described above, as well, in a case where the interchangeable lens includes the rotation-limited ring to which a plurality of functions can be selectively allocated, a function different from a function allocated to the rotation-limited ring is allocated to the endless ring provided on the interchangeable lens or another accessory apparatus. Accordingly, discrepancy between the rotational position of the rotation-limited ring and a set value due to allocation of the same function to the rotation-limited ring and the endless ring can be avoided to achieve excellent operability of the interchangeable lens.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD) TM), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

According to the present disclosure, in a case where multiple functions are allocatable to each of first and second operation rings, the functions can be appropriately allocated to the first and second operation rings.

This application claims priority to Japanese Patent Application No. 2024-010210, which was filed on Jan. 26, 2024, and which is hereby incorporated by reference herein in its entirety.

What is claimed is:

1. An image pickup apparatus to which a first accessory apparatus including a first operation ring that has a rotational end is connectable, the image pickup apparatus comprising:
a processor (a) configured to, in a case where the first accessory apparatus or a second accessory apparatus connected to the image pickup apparatus together with the first accessory apparatus includes a second operation ring that has no rotational end, allocate functions related to control of the first accessory apparatus or the image pickup apparatus to the first and second operation rings, and (b) configured to perform the control in accordance with operations of the first and second operation rings,
wherein the processor (a) allocates a first function to the first operation ring, and (b), in a case where the first function is included in functions allocatable to the second operation ring, allocates a second function different from the first function to the second operation ring or restricts allocation of the first function to the second operation ring.

2. The image pickup apparatus according to claim 1, wherein the first and second functions are functions for controlling mutually different control targets in the first accessory apparatus or the image pickup apparatus.

3. The image pickup apparatus according to claim 1, wherein the first and second functions are functions for providing mutually different set values in control of a same control target in the first accessory apparatus or the image pickup apparatus.

4. The image pickup apparatus according to claim 1, wherein the processor generates, based on information related to the first operation ring that is acquired from the first accessory apparatus, information related to a set value for the control in accordance with a rotational position of the first operation ring in the first function.

5. The image pickup apparatus according to claim 4, wherein the information related to the first operation ring includes (a) the set value corresponding to an actual position of the first operation ring and (b) maximum and minimum values of the set value within a range in which the first operation ring is operable.

6. The image pickup apparatus according to claim 1, wherein the processor allocates the first and second functions to the first and second operation rings based on information related to a configuration of at least one of the first and second operation rings that is acquired from the first or second accessory apparatus.

7. The image pickup apparatus according to claim 1, wherein, when allocating the second function to the second operation ring, the processor allocates, to the second operation ring as the second function, a disabling function by which the control in accordance with the operation of the second operation ring is not performed.

8. The image pickup apparatus according to claim 1,
wherein the processor is capable of allocating, to each of the first and second operation rings, a first control function that causes the image pickup apparatus to control a first control target in accordance with the operation of each of the first and second operation rings,
wherein the processor is capable of allocating to the first operation ring a second control function that causes the first accessory apparatus to control the first control target in accordance with the operation of the first operation ring not through the image pickup apparatus, and
wherein, when allocating the first function that is the first control function or the second control function to the first operation ring, the processor allocates, to the second operation ring, the second function that is different from the first and second control functions.

9. The image pickup apparatus according to claim 8,
wherein the functions allocatable to the second operation ring include a disabling function by which the control in accordance with the operation of the second operation ring is not performed, and
wherein the disabling function is the second function that is different from the first and second control functions.

10. The image pickup apparatus according to claim 1,
wherein the processor is capable of allocating to at least one of the first and second operation rings a second control function that causes the first accessory apparatus to control a first control target in accordance with the operation of the at least one operation ring not through the image pickup apparatus, and
wherein, in a case where the second control function is allocated to the at least one operation ring, the processor performs communication for causing the first accessory apparatus to control the first control target in the second control function.

11. The image pickup apparatus according to claim 1, wherein the processor allocates the second function that is different from the first function and is selected by a user to the second operation ring.

12. The image pickup apparatus according to claim 1, wherein, when restricting the allocation of the first function to the second operation ring, the processor restricts selection of the first function by a user as a function to be allocated to the second operation ring.

13. An image pickup apparatus comprising a processor configured to:
allocate functions to a first operation ring having a rotational end and a second operation ring having no rotational end, and
perform control in accordance with operations of the first and second operation rings in the functions allocated to the first and second operation rings,
wherein the processor allocates, to the first operation ring, the function different from that allocated to the second operation ring in a case where the functions allocatable to the first operation ring include at least part of the functions allocatable to the second operation ring.

14. An accessory apparatus connectable to an image pickup apparatus, the accessory apparatus comprising:
a first operation ring having a rotational end;
a second operation ring having no rotational end; and
a processor configured to transmit to the image pickup apparatus information enabling control in accordance with an operation of each of the first and second operation rings in a function allocated to each of the first and second operation rings.

15. The accessory apparatus according to claim 14, wherein the processor transmits to the image pickup apparatus information related to the first operation ring that is used to generate information related to a set value for the control in accordance with a rotational position of the first operation ring in a first function of the image pickup apparatus.

16. The accessory apparatus according to claim 14, wherein the processor transmits to the image pickup apparatus information in accordance with the operation of the first operation ring in a case where a first control function that causes the image pickup apparatus to control a first control target in accordance with the operation of the first operation ring is allocated to the first operation ring, and
wherein the processor controls the first control target in accordance with the operation of the first operation ring in a case where a second control function that causes the accessory apparatus to control the first control target in accordance with the operation of the first operation ring not through the image pickup apparatus is allocated to the first operation ring.

17. A control method of an image pickup apparatus to which a first accessory apparatus including a first operation ring that has a rotational end is connectable, the control method comprising the steps of:
allocating, in a case where the first accessory apparatus or a second accessory apparatus connected to the image pickup apparatus together with the first accessory apparatus includes a second operation ring that has no rotational end, functions related to control of the first accessory apparatus or the image pickup apparatus to the first and second operation rings; and
performing the control in accordance with operations of the first and second operation rings,
wherein the method (a) allocates a first function to the first operation ring, and (b), in a case where the first function is included in functions allocatable to the second operation ring, allocates a second function different from the first function to the second operation ring or restricts allocation of the first function to the second operation ring.

18. A control method of an image pickup apparatus, the control method comprising the steps of:
allocating functions to a first operation ring having a rotational end and a second operation ring having no rotational end; and
performing control in accordance with operations of the first and second operation rings in the functions allocated to the first and second operation rings,
wherein the method allocates, to the first operation ring, the function different from that allocated to the second operation ring in a case where the functions allocatable to the first operation ring include at least part of the functions allocatable to the second operation ring.
